(19) United States
(12) Patent Application Publication
(10) Pub. No.: US 2026/0251015 A1
(43) Pub. Date: Aug. 27, 2026

(54) STEP STOOL WITH BRACKET-RECEIVING EXTRUDED CHANNEL

(71) Applicant: Dorel Home Furnishings, Inc., Wright City, MO (US)

(72) Inventor: Kyle J. Lawrence, Greenfield, IN (US)

(21) Appl. No.: 19/540,280

(22) Filed: Feb. 13, 2026

Related U.S. Application Data
(60) Provisional application No. 63/761,853, filed on Feb. 21, 2025.

(51) Int. Cl. E06C 1/393; A47C 12/02; E06C 1/00; E06C 1/39; E06C 7/18

(52) U.S. Cl. CPC E06C 1/393; A47C 12/02; E06C 1/005; E06C 1/39; E06C 7/185

(57) ABSTRACT

A foldable step stool includes an expandable step frame, steps pivotably coupled to the expandable step frame, and a releasable step-retainer lock coupled to one of the steps. The step-retainer lock is operable to block movement the expandable step frame when the foldable step stool has been opened.

### PRIORITY CLAIM

This application claims priority under 35 U.S.C. § 119(e) to U.S. Provisional Application Ser. No. 63/761,853, filed Feb. 21, 2025, which is expressly incorporated by reference herein.

### BACKGROUND

The present disclosure relates to a foldable step stool, and particularly to a step stool including a frame having front and rear legs that move relative to one another during opening and closing of the step stool. More particularly, the present disclosure relates to a foldable step stool having a lock for locking the frame to one of the steps that are pivotably mounted on the frame once the foldable step stool has been opened.

### SUMMARY

A step stool in accordance with the present disclosure is reconfigurable from a COLLAPSED-STORAGE mode to an EXPANDED-USE mode. A step-retainer lock is provided to selectively hold the step stool in the EXPANDED-USE mode. The step-retainer lock is mounted to a top step of the step stool and engages a crossbar included in a frame of the step stool to hold the step stool in the EXPANDED-USE mode.

In illustrative embodiments, the top step includes extruded components that are shaped to form a bracket-receiving channel on the underside of the top step. The step-retainer lock is held in the bracket-receiving channel to couple the step-retainer lock to the top step. In this way, mounting of the lock to the top step is accomplished while avoiding fasteners or other blemishes on a top side of the top step.

In illustrative embodiments, the step-retainer lock includes a bracket and a pivotable latch. The bracket is received in the bracket-receiving channel of the top step. The pivotable latch is coupled to the bracket to between a normally locked position (arranged to engage the crossbar of the frame) and an unlocked position (arranged to free the crossbar of the frame). The bracket can include retainer tabs fixed to a rear rail of the top step via fasteners to hold the lock in place along the bracket-receiving channel.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a front perspective view of a foldable step stool showing the step stool includes a top step, relatively smaller lower steps, and an expandable step frame configured to support the top step and lower steps during a change in the frame from a COLLAPSED-STORAGE mode shown in FIG. 1 to an EXPANDED-USE mode as shown in FIG. 2, the frame including a front leg unit pivotably coupled to a rear leg unit, and further showing a top side of the top step being free of faster-receiver holes;

FIG. 2 is a front perspective view of the foldable step stool from FIG. 1 showing the unfolded step stool when the frame is in the EXPANDED-USE mode with a releasable step-retainer lock in an engaged state holding the foldable step stool in the EXPANDED-USE mode until it is released by a user;

FIG. 3 is a rear perspective view of the foldable step stool from FIG. 1 in the COLLAPSED-STORAGE mode showing that the releasable step-retainer lock is mounted to the top step along a forward edge of the top step and showing that the expandable step frame includes a crossbar arranged to be engaged by the releasable step-retainer lock when the foldable step stool is in the EXPANDED-USE mode;

FIG. 4 is a perspective view of a portion of the top step and the releasable step-retainer lock showing that the top step includes a tread panel, a rear rail that extends downwardly from the rear side of the tread panel, and a bracket hook that cooperates with the tread panel and an interior face of the of the rear rail to define a bracket-receiving channel; and further showing that the releasable step-retainer lock includes a bracket arranged in bracket-receiving channel to couple the releasable step-retainer lock to the top step and a pivotable latch supported for rotation relative to the top step by the bracket;

FIG. 5 is a cross-sectional view of the top step and the releasable step-retainer lock showing the releasable step-retainer lock coupled to along the rear rail of the top step;

FIG. 6 is a detail view of a portion of FIG. 5 showing that the bracket of the releasable step-retainer lock includes a main body arranged in the bracket-receiving channel of the top step, a support arm that extends from the main body along the interior face of the rear rail of the top step, a latch-mount tab that extends from the support arm away from the rear rail of the top step so as to support the pivotable latch, and a retainer tab that extends along a bottom surface of the rear rail of the top step so as to fix the bracket in place along the bracket-receiving channel via fasteners therethrough;

FIG. 7 is a bottom view of a portion of the top step and the releasable step-retainer lock showing holes in the retainer tabs of the bracket suitable for receiving fasteners that extend into the rear rail of the top step to fix the bracket in place along the rear side of the top step;

FIG. 8 is an exploded perspective view of a portion of the top step and the bracket of the releasable step lock showing the bracket-receiving channel formed by the top step into which the bracket slides before being fixed in place by fasteners through the retainer tabs of the bracket;

FIG. 9 is a perspective view of the top step without end caps showing that the top step is formed from extruded planks of metallic (illustratively aluminum) material for ease of manufacture and weight savings;

FIG. 10 is an exploded perspective view of the top step without end caps showing the front, middle, and rear extruded planks that make up the top step of the illustrated design;

FIG. 11 is a side elevation view of the top step without end caps showing the profile of the extruded planks;

FIG. 12 is a detail view of a portion of the top step without end caps from FIG. 11 showing a rear portion of the rear extruded plank included in the top step being shaped to provide the tread panel, the rear rail that extends downwardly from the rear of the tread panel, and the bracket hook that cooperates with the tread panel and the rear rail to define the bracket-receiving channel; and

FIG. 13 is an enlarged perspective view of the step stool in the EXPANDED-USE mode.

### DETAILED DESCRIPTION

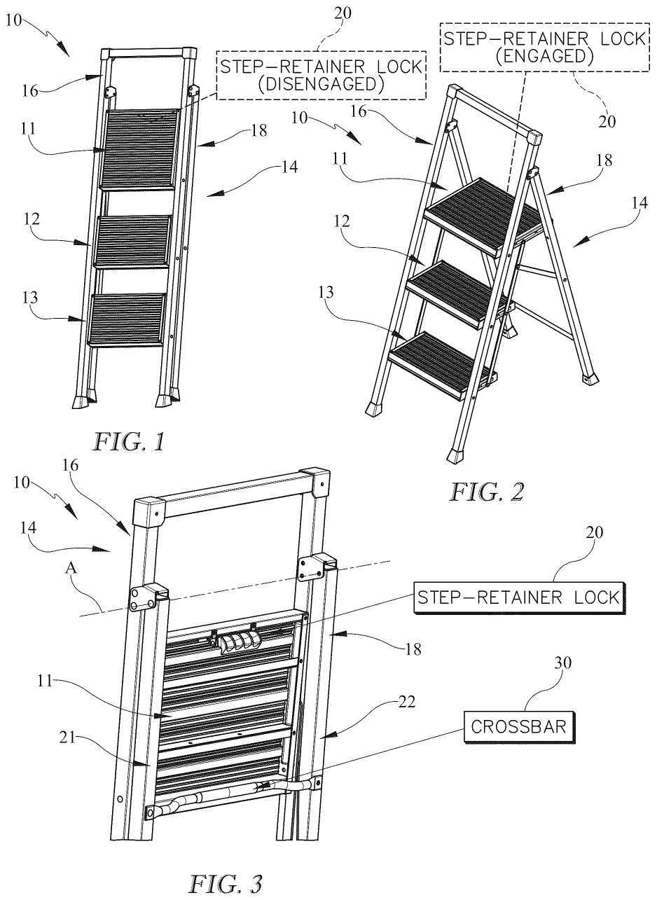

A foldable step stool 10 according to the present disclosure is reconfigurable from a COLLAPSED-STORAGE mode, as shown in FIG. 1, to an EXPANDED-USE mode as shown in FIG. 2. The step stool 10 illustratively includes steps 11, 12, 13 mounted to a frame 14. The top step 11 in the illustrative embodiment is larger than the lower steps 12, 13. The frame 14 includes a front leg unit 16 pivotably coupled to a rear leg unit 18.

A releasable step-retainer lock 20 provides means for holding the foldable step stool 10 in the EXPANDED-USE mode until released by a user. The lock 20 is illustratively mounted to the top step 11 and engages the frame 14 when the step stool 10 is in the EXPANDED-USE mode. Mounting of the lock 20 to the top step 11 is accomplished in such a way to avoid fasteners or other blemishes on the top side of the top step 11. In particular, the lock 20 is mounted in a channel formed on the underside of the top step 11 as discussed in this paper.

The frame 14 in the illustrated embodiment includes a front leg unit 16 and a rear leg unit 18 as shown in FIGS. 1 and 2. The front and rear leg units 16, 18 are coupled to one another to pivot about an axis A as the step stool 10 moves between the COLLAPSED-STORAGE mode and the EXPANDED-USE mode. The rear leg unit 18 includes a crossbar 30 that interconnects rear legs 21, 22 at a location spaced apart from the axis A.

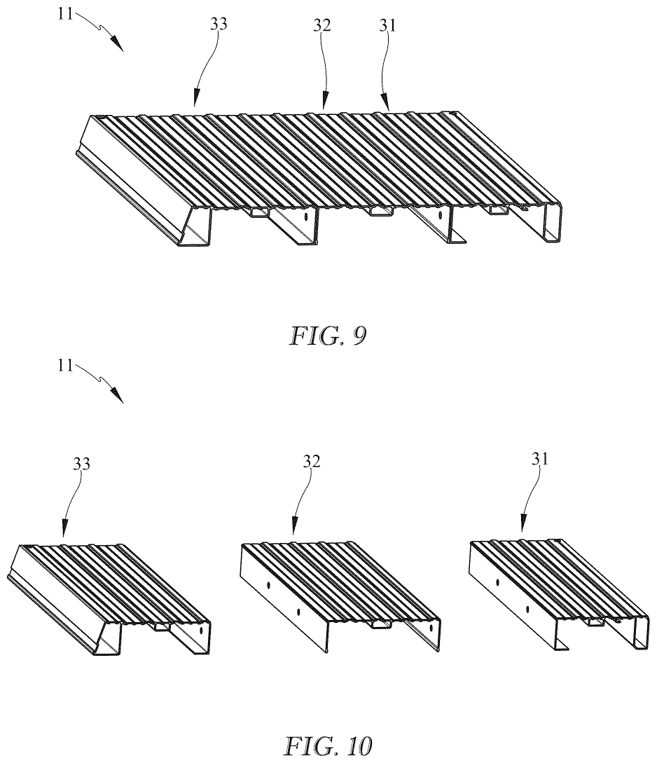

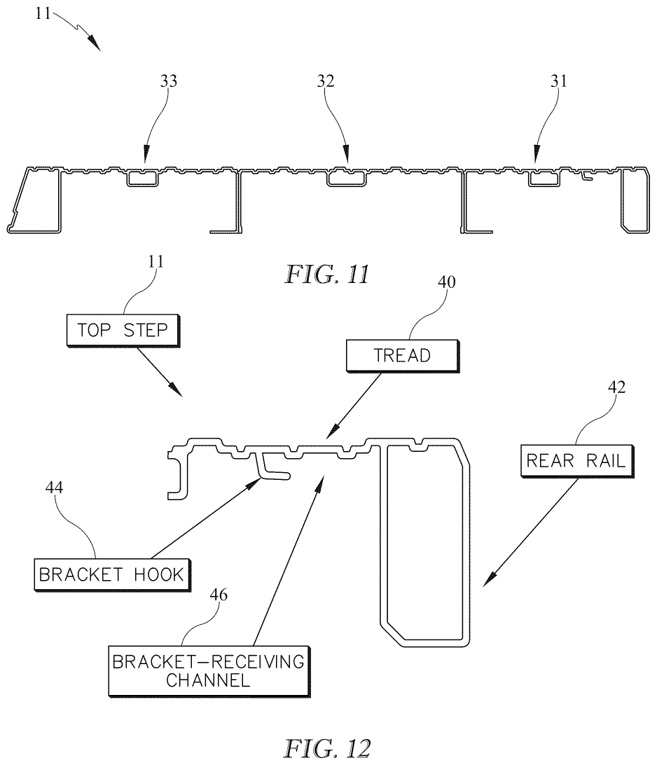

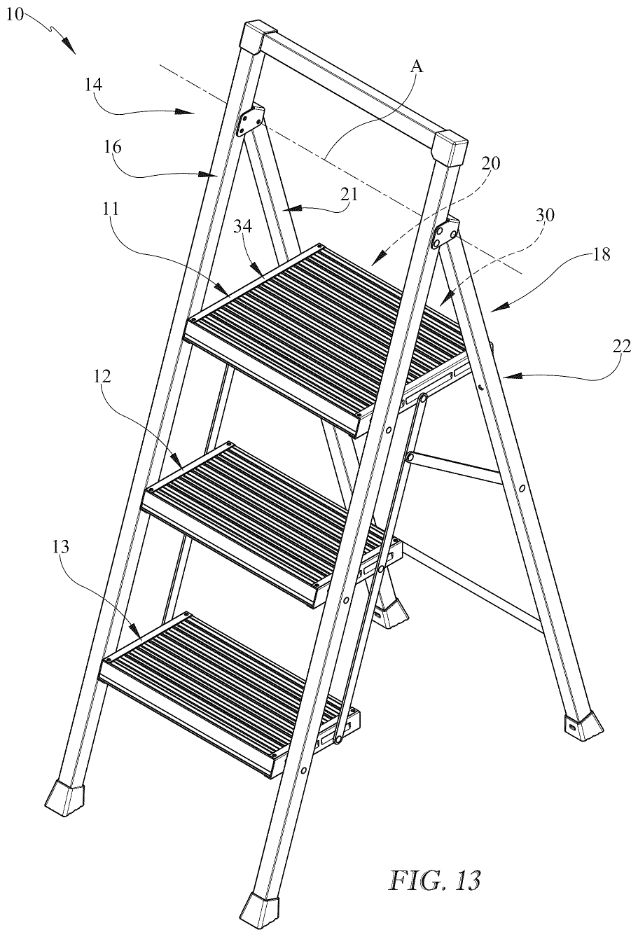

The top step 11 is constructed, at least in part, from extruded metallic materials (aluminum) as suggested in FIGS. 9-13. More specifically, in the illustrated embodiment, the top step 11 is made up of extruded planks 31, 32, 33 and end caps 34. The extruded planks 31, 32, 33 are coupled to one another via fasteners. The end caps 34 extend down along sides of the assembled extruded planks 31, 32, 33 to block access to the extruded features of the planks 31, 32, 33 from the sides of the top step 11.

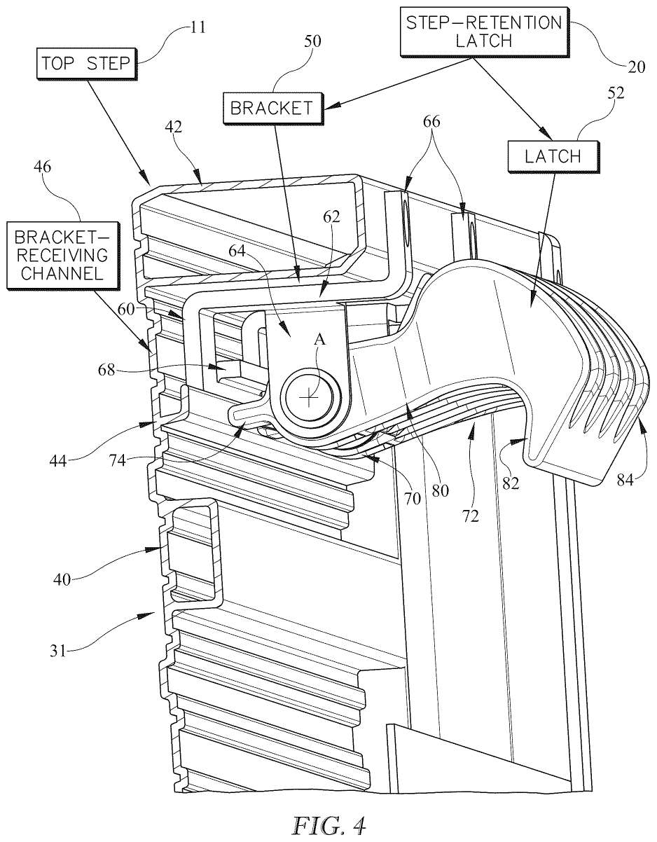

When coupled to one another, the extruded planks 31, 32, 33 cooperate so that the top step 11 includes a tread panel 40, a rear rail 42, and a bracket hook 44 as shown in FIGS. 4, 6, and 12. The tread panel 40 has a top side upon which a user can step and a bottom side from which other features extend. The rear rail 42 extends downwardly from the rear side of the tread panel 40. The bracket hook 44 has an L-shape when viewed across the extrusion 31. The tread panel 40, an interior face of the of the rear rail 42, and the bracket hook 44 cooperate to define a bracket-receiving channel 46. The bracket-receiving channel 46 accepts the lock 20 when it is mounted to the top step 11.

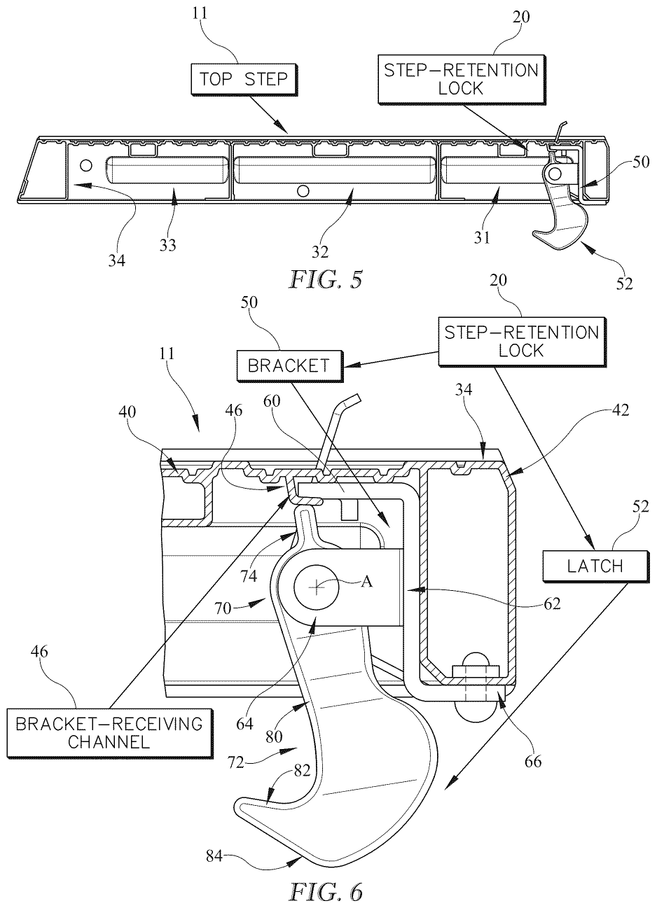

The releasable step-retainer lock 20 is mounted in the bracket-receiving channel 46 of the top step 11 along a rear edge of the top step 11 as shown in FIGS. 3-6. The lock 20 includes a bracket 50 and a pivotable latch 52 as shown in FIG. 4. The bracket 50 is arranged in bracket-receiving channel 46 to couple the lock 20 to the top step 11. The pivotable latch 52 is supported for rotation relative to the top step 11 by the bracket 50. A spring 55 biases the latch 52 toward a normally retracted position associated with an engaged position in which the latch 52 engages the crossbar 30 when the step stool 10 is in the EXPANDED-USE mode to block movement of the step stool 10 toward the COLLAPSED-STORAGE MODE.

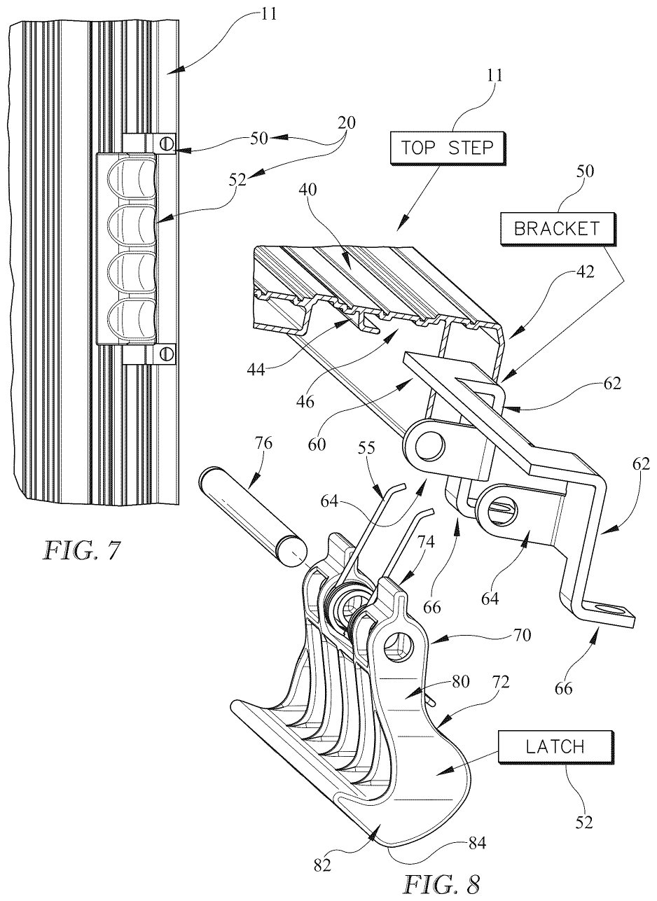

The bracket 50 of the releasable step-retainer lock 20 is illustratively made from a stamped and bent sheet of metallic material (illustratively steel) as shown in FIGS. 4 and 8. The bracket 50 includes a main body 60, support arms 62, latch-mount tabs 64, and retainer tabs 66. The main body 60 is arranged in the bracket-receiving channel 46 of the top step 11. The support arms 62 that extend from the main body 60 along the interior face of the rear rail 42 of the top step 11. The latch-mount tabs 64 extend from the support arms 62 away from the rear rail 42 of the top step 11 and support the pivotable latch 52. The retainer tabs 66 extend along a bottom surface of the rear rail 42 of the top step 11 so as to fix the bracket 50 in place along the bracket-receiving channel 46 via fasteners.

In the illustrative embodiment, the bracket 50 also includes a limiter tab 68 as shown in FIGS. 4 and 6. The limiter tab 68 extends from the main body 60 away from the tread panel at a location spaced apart from the support arms 62.

The latch 52 includes a hub 70, a catch 72, and a limiter arm 74 as shown in FIGS. 4, 6, and 8. The hub 70 is supported by a pin 76 that extends through the latch-mount tabs 74 of the bracket 50. The catch 72 extends in a first direction away from the latch pivot axis A and is arranged to engage the crossbar 30 when the step stool 10 is in the expanded-use mode. The limiter arm 74 extends in a second direction, opposite the first direction, away from the latch pivot axis A. The limiter arm 74 is arranged to contact the limiter tab 68 of the bracket 50 when the latch 52 is in the retracted. In this way, the limiter arm 74 blocks further rotation of the latch 42 in a retraction direction around the latch axis A to hold the latch in the retracted position, while still allowing for rotation of the latch 52 in an extension direction around the latch axis, opposite the retraction direction.

The catch 72 has an extension arm 80, a retention ledge 82, and a cam surface 84 as shown in FIGS. 4, 6, and 8. The extension arm 80 extends away from the latch axis A. The retention ledge 82 extends from the extension arm 80 at a location spaced apart from the latch axis A to form an L-shape. The cam surface 84 is arranged (1) to contact the cross bar 30 during motion of the rear leg unit 18 toward the expanded-use mode, (2) to direct motion of the latch 52 from the retracted position to an extended position while contacting the crossbar 30 to thereby allow the rear leg unit to reach an expanded-use mode, and (3) to release the latch 52 to return to the retracted position arranged to engage the crossbar 30 to block movement of the rear leg 18 away from the expanded-use mode.

It is contemplated that in other embodiments the retainer tabs 66 may be omitted and that other means may be used to fix the bracket 50 in place along the channel 46. In one such embodiment, dog ears may be cut in the bracket hook 44 and bent over on opposed sides of the bracket 50 upon assembly into the channel 46 to block sliding of the bracket 50 along the channel 46. Blocking rivets and other features to hold the bracket 50 in the channel 46 are also contemplated.

The following clauses provide for various optional features of the present disclosure. It is appreciated that many different combinations of the below features are inventive.

According to one method of making and or using the disclosed step stool, a number of steps might be taken. In particular, the step planks may be extruded with a common cross section. Then the planks may be assembled into a top step. The latch may be coupled to the bracket via the pin and spring. The bracket may be coupled to the step by inserting at least a portion of the bracket into the receiving channel formed by the top step and/or by fixing the bracket to the step with fasteners. The top step and step retainer lock may be coupled to the expandable step frame.

Clause 1: A foldable step stool comprising
an expandable step frame including a front leg unit and a rear leg unit an expandable step frame including a front leg unit and a rear leg unit pivotably coupled to the front leg unit at a leg-pivot axis for pivotable movement relative to the front leg unit during a change in the expandable step frame from a collapsed-storage mode in which the rear leg unit lies alongside the front leg unit to an expanded-use mode in which ground-engaging lower ends of the rear leg unit and the front leg unit are separated to establish an acute angle between the front and rear leg units, the rear leg unit including first and second rear legs and a crossbar arranged to interconnect the first and second rear legs,
a top step including a tread panel, a rear rail that extends downwardly from the rear side of the tread panel, and a bracket hook that cooperates with the tread panel and an interior face of the of the rear rail to define a bracket-receiving channel, and
a releasable step-retainer lock including a bracket arranged at least in part in the bracket-receiving channel of the top step and a latch supported by the bracket for pivotable movement about a latch-pivot axis relative to the top step to selectively engage the crossbar of the step frame when the step frame is in the expanded-use mode to stabilize the expandable step frame when the step stool is opened to the expanded-use mode.

Clause 2. The foldable step stool of clause 1, any other suitable clause, or any suitable combination of clauses, wherein the top step includes an extruded plank that forms the bracket-receiving channel and the bracket-receiving channel extends across substantially all of a width of the top step.

Clause 3. The foldable step stool of clause 1, any other suitable clause, or any suitable combination of clauses, wherein the bracket includes a main body arranged in the bracket-receiving channel of the top step, a support arm that extends from the main body, and a latch-mount tab that extends from the support arm away from the rear of the top step so as to support the pivotable latch.

Clause 4. The foldable step stool of clause 3, any other suitable clause, or any suitable combination of clauses, wherein the bracket includes a retainer tab that extends along a bottom surface of the top step so as to fix the bracket in place along the bracket-receiving channel via fasteners that extend through the retainer tab.

Clause 5. The foldable step stool of clause 1, any other suitable clause, or any suitable combination of clauses, wherein the latch is biased by a spring toward a retracted position in which the latch is arranged to engage the crossbar of the step frame when the step frame is in the expanded-use mode.

Clause 6. The foldable step stool of clause 5, any other suitable clause, or any suitable combination of clauses, wherein the latch includes a catch that extends in a first direction away from the latch pivot axis that is arranged to engage the crossbar of the step frame when the step frame is in the expanded-use mode.

Clause 7. The foldable step stool of clause 6, any other suitable clause, or any suitable combination of clauses, wherein the latch includes a limiter arm that extends in a second direction, opposite the first direction, away from the latch pivot axis, and wherein the limiter arm is arranged to contact the bracket when the latch is in the retracted to block further rotation of the latch in a retraction direction around the latch axis and hold the latch in the retracted position while still allowing for rotation of the latch in an extension direction around the latch axis.

Clause 8. The foldable step stool of clause 6, any other suitable clause, or any suitable combination of clauses, wherein the catch has an extension arm that extends away from the latch axis, a retention ledge that extends from the extension arm at a location spaced apart from the latch axis to form an L-shape, and a cam surface arranged (1) to contact the cross bar during motion of the rear leg unit toward the expanded-use mode, (2) to direct motion of the latch from the retracted position to an extended position while contacting the crossbar to thereby allow the rear leg unit to reach an expanded-use mode, and/or (3) to release the latch to return to the retracted position arranged to engage the crossbar to block movement of the rear leg away from the expanded-use mode.

Clause 9. The foldable step stool of clause 8, any other suitable clause, or any suitable combination of clauses, wherein the latch includes a limiter arm that extends in a second direction, opposite the first direction, away from the latch pivot axis wherein the limiter arm is arranged to contact the bracket when the latch is in the retracted to block further rotation of the latch in a retraction direction around the latch axis and hold the latch in the retracted position.

Clause 10. The foldable step stool of clause 9, any other suitable clause, or any suitable combination of clauses, wherein the bracket includes a main body arranged in the bracket-receiving channel of the top step, a support arm that extends from the main body away from the tread panel, and a latch-mount tab that extends from the support arm away from the rear of the top step so as to support the pivotable latch via a pivot pin.

Clause 11. The foldable step stool of clause 10, any other suitable clause, or any suitable combination of clauses, wherein the bracket includes a limiter tab that extends from the main body away from the tread panel at a location spaced apart from the support arm, and wherein the limiter arm of the latch contacts the limiter tab when the latch is in the retracted to block further rotation of the latch in a retraction direction around the latch axis and hold the latch in the retracted position.

Clause 12. The foldable step stool of clause 11, any other suitable clause, or any suitable combination of clauses, wherein the bracket includes a retainer tab that extends from the support arm along a bottom surface of the top step so as to fix the bracket in place along the bracket-receiving channel via fasteners that extend through the retainer tab.

Clause 13. A foldable step stool comprising
an expandable step frame including a front leg unit and a rear leg unit pivotably coupled to the front leg unit at a leg-pivot axis for pivotable movement relative to the front leg unit during a change in the expandable step frame from a collapsed-storage mode in which the rear leg unit lies alongside the front leg unit to an expanded use mode in which ground-engaging lower ends of the rear leg unit and the front leg unit are separated to establish an acute angle between the front and rear leg units, the rear leg unit including first and second rear legs and a crossbar arranged to interconnect the first and second rear legs,
a top step including an extruded plank, the extruded plank formed to have a constant cross-sectional shape that provides (i) a tread panel with a top face arranged to provide an upwardly facing step surface when the expandable step frame is in the expanded-use mode and (ii) a bracket-receiving channel arranged along a bottom face of the tread panel, opposite the top face, and
a releasable step-retainer lock including a bracket arranged at least in part in the bracket-receiving channel of the top step and a latch supported by the bracket for movement relative to the top step to engage the crossbar of the step frame when the step frame is in the expanded-use mode to stabilize the expandable step frame when the step stool is opened and to disengage the crossbar of the step frame when the step frame is in the collapsed-storage mode and the step stool is closed.

Clause 14. The foldable step stool of clause 13, any other suitable clause, or any suitable combination of clauses, wherein the top step includes a rear rail that extends downwardly from the rear side of the tread panel and a bracket hook that cooperates with the tread panel and an interior face of the of the rear rail to define the bracket-receiving channel.

Clause 15. The foldable step stool of clause 13, any other suitable clause, or any suitable combination of clauses, wherein the bracket includes a main body arranged in the bracket-receiving channel of the top step, a support arm that extends from the main body, and a latch-mount tab that extends from the support arm away from the rear of the top step so as to support the pivotable latch.

Clause 16. The foldable step stool of clause 12, any other suitable clause, or any suitable combination of clauses, wherein the latch is biased by a spring toward a retracted position in which the latch is arranged to engage the crossbar of the step frame when the step frame is in the expanded-use mode.

Clause 17. The foldable step stool of clause 16, any other suitable clause, or any suitable combination of clauses, wherein the latch includes a catch that extends in a first direction away from the latch pivot axis that is arranged to engage the crossbar of the step frame when the step frame is in the expanded-use mode.

Clause 18. The foldable step stool of clause 17, any other suitable clause, or any suitable combination of clauses, wherein the latch includes a limiter arm that extends in a second direction, opposite the first direction, away from the latch pivot axis wherein the limiter arm is arranged to contact the bracket when the latch is in the retracted to block further rotation of the latch in a retraction direction around the latch axis and hold the latch in the retracted position while still allowing for rotation of the latch in an extension direction around the latch axis.

Clause 19. The foldable step stool of clause 17, any other suitable clause, or any suitable combination of clauses, wherein the bracket includes a main body arranged in the bracket-receiving channel of the top step, a support arm that extends from the main body, a latch-mount tab that extends from the support arm away to support the pivotable latch, and a limiter tab that extends from the main body away from the tread panel at a location spaced apart from the support arm, and wherein the limiter arm of the latch contacts the limiter tab when the latch is in the retracted to block further rotation of the latch in a retraction direction around the latch axis and hold the latch in the retracted position.

Clause 20. The foldable step stool of clause 17, any other suitable clause, or any suitable combination of clauses, wherein the catch has an extension arm that extends away from the latch axis, a retention ledge that extends from the extension arm at a location spaced apart from the latch axis to form an L-shape, and a cam surface arranged (1) to contact the cross bar during motion of the rear leg unit toward the expanded-use mode, (2) to direct motion of the latch from the retracted position to an extended position while contacting the crossbar to thereby allow the rear leg unit to reach an expanded-use mode, and/or (3) to release the latch to return to the retracted position arranged to engage the crossbar to block movement of the rear leg away from the expanded-use mode

1. A foldable step stool comprising
an expandable step frame including a front leg unit and a rear leg unit pivotably coupled to the front leg unit at a leg-pivot axis for pivotable movement relative to the front leg unit during a change in the expandable step frame from a collapsed-storage mode in which the rear leg unit lies alongside the front leg unit to an expanded-use mode in which ground-engaging lower ends of the rear leg unit and the front leg unit are separated to establish an acute angle between the front and rear leg units, the rear leg unit including first and second rear legs and a crossbar arranged to interconnect the first and second rear legs,
a top step including a tread panel, a rear rail that extends downwardly from the rear side of the tread panel, and a bracket hook that cooperates with the tread panel and an interior face of the of the rear rail to define a bracket-receiving channel, and
a releasable step-retainer lock including a bracket arranged at least in part in the bracket-receiving channel of the top step and a latch supported by the bracket for pivotable movement about a latch-pivot axis relative to the top step to selectively engage the crossbar of the step frame when the step frame is in the expanded-use mode to stabilize the expandable step frame when the step stool is opened to the expanded-use mode.

2. The foldable step stool of claim 1, wherein the top step includes an extruded plank that forms the bracket-receiving channel and the bracket-receiving channel extends across substantially all of a width of the top step.

3. The foldable step stool of claim 1, wherein the bracket includes a main body arranged in the bracket-receiving channel of the top step, a support arm that extends from the main body, and a latch-mount tab that extends from the support arm away from the rear of the top step so as to support the pivotable latch.

4. The foldable step stool of claim 3, wherein the bracket includes a retainer tab that extends along a bottom surface of the top step so as to fix the bracket in place along the bracket-receiving channel via fasteners that extend through the retainer tab.

5. The foldable step stool of claim 1, wherein the latch is biased by a spring toward a retracted position in which the latch is arranged to engage the crossbar of the step frame when the step frame is in the expanded-use mode.

6. The foldable step stool of claim 5, wherein the latch includes a catch that extends in a first direction away from the latch pivot axis that is arranged to engage the crossbar of the step frame when the step frame is in the expanded-use mode.

7. The foldable step stool of claim 6, wherein the latch includes a limiter arm that extends in a second direction, opposite the first direction, away from the latch pivot axis, and wherein the limiter arm is arranged to contact the bracket when the latch is in the retracted to block further rotation of the latch in a retraction direction around the latch axis and hold the latch in the retracted position while still allowing for rotation of the latch in an extension direction around the latch axis.

8. The foldable step stool of claim 6, wherein the catch has an extension arm that extends away from the latch axis, a retention ledge that extends from the extension arm at a location spaced apart from the latch axis to form an L-shape, and a cam surface arranged (1) to contact the cross bar during motion of the rear leg unit toward the expanded-use mode, (2) to direct motion of the latch from the retracted position to an extended position while contacting the crossbar to thereby allow the rear leg unit to reach an expanded-use mode, and (3) to release the latch to return to the retracted position arranged to engage the crossbar to block movement of the rear leg away from the expanded-use mode.

9. The foldable step stool of claim 8, wherein the latch includes a limiter arm that extends in a second direction, opposite the first direction, away from the latch pivot axis wherein the limiter arm is arranged to contact the bracket when the latch is in the retracted to block further rotation of the latch in a retraction direction around the latch axis and hold the latch in the retracted position.

10. The foldable step stool of claim 9, wherein the bracket includes a main body arranged in the bracket-receiving channel of the top step, a support arm that extends from the main body away from the tread panel, and a latch-mount tab that extends from the support arm away from the rear of the top step so as to support the pivotable latch via a pivot pin.

11. The foldable step stool of claim 10, wherein the bracket includes a limiter tab that extends from the main body away from the tread panel at a location spaced apart from the support arm, and wherein the limiter arm of the latch contacts the limiter tab when the latch is in the retracted to block further rotation of the latch in a retraction direction around the latch axis and hold the latch in the retracted position.

12. The foldable step stool of claim 11, wherein the bracket includes a retainer tab that extends from the support arm along a bottom surface of the top step so as to fix the bracket in place along the bracket-receiving channel via fasteners that extend through the retainer tab.

13. A foldable step stool comprising
an expandable step frame including a front leg unit and a rear leg unit pivotably coupled to the front leg unit at a leg-pivot axis for pivotable movement relative to the front leg unit during a change in the expandable step frame from a collapsed-storage mode in which the rear leg unit lies alongside the front leg unit to an expanded use mode in which ground-engaging lower ends of the rear leg unit and the front leg unit are separated to establish an acute angle between the front and rear leg units, the rear leg unit including first and second rear legs and a crossbar arranged to interconnect the first and second rear legs,
a top step including an extruded plank, the extruded plank formed to have a constant cross-sectional shape that provides (i) a tread panel with a top face arranged to provide an upwardly facing step surface when the expandable step frame is in the expanded-use mode and (ii) a bracket-receiving channel arranged along a bottom face of the tread panel, opposite the top face, and
a releasable step-retainer lock including a bracket arranged at least in part in the bracket-receiving channel of the top step and a latch supported by the bracket for movement relative to the top step to engage the crossbar of the step frame when the step frame is in the expanded-use mode to stabilize the expandable step frame when the step stool is opened and to disengage the crossbar of the step frame when the step frame is in the collapsed-storage mode and the step stool is closed.

14. The foldable step stool of claim 13, wherein the top step includes a rear rail that extends downwardly from the rear side of the tread panel and a bracket hook that cooperates with the tread panel and an interior face of the of the rear rail to define the bracket-receiving channel.

15. The foldable step stool of claim 13, wherein the bracket includes a main body arranged in the bracket-receiving channel of the top step, a support arm that extends from the main body, and a latch-mount tab that extends from the support arm away from the rear of the top step so as to support the pivotable latch.

16. The foldable step stool of claim 12, wherein the latch is biased by a spring toward a retracted position in which the latch is arranged to engage the crossbar of the step frame when the step frame is in the expanded-use mode.

17. The foldable step stool of claim 16, wherein the latch includes a catch that extends in a first direction away from the latch pivot axis that is arranged to engage the crossbar of the step frame when the step frame is in the expanded-use mode.

18. The foldable step stool of claim 17, wherein the latch includes a limiter arm that extends in a second direction, opposite the first direction, away from the latch pivot axis wherein the limiter arm is arranged to contact the bracket when the latch is in the retracted to block further rotation of the latch in a retraction direction around the latch axis and hold the latch in the retracted position while still allowing for rotation of the latch in an extension direction around the latch axis.

19. The foldable step stool of claim 17, wherein the bracket includes a main body arranged in the bracket-receiving channel of the top step, a support arm that extends from the main body, a latch-mount tab that extends from the support arm away to support the pivotable latch, and a limiter tab that extends from the main body away from the tread panel at a location spaced apart from the support arm, and wherein the limiter arm of the latch contacts the limiter tab when the latch is in the retracted to block further rotation of the latch in a retraction direction around the latch axis and hold the latch in the retracted position.

20. The foldable step stool of claim 17, wherein the catch has an extension arm that extends away from the latch axis, a retention ledge that extends from the extension arm at a location spaced apart from the latch axis to form an L-shape, and a cam surface arranged (1) to contact the cross bar during motion of the rear leg unit toward the expanded-use mode, (2) to direct motion of the latch from the retracted position to an extended position while contacting the crossbar to thereby allow the rear leg unit to reach an expanded-use mode, and (3) to release the latch to return to the retracted position arranged to engage the crossbar to block movement of the rear leg away from the expanded-use mode.
